(19) United States
(12) Patent Application Publication
(10) Pub. No.: US 2025/0335722 A1
(43) Pub. Date: Oct. 30, 2025

(54) QUESTION ANSWERING METHOD, ELECTRONIC DEVICE, AND STORAGE MEDIUM

(71) Applicant: Lenovo (Beijing) Limited, Beijing (CN)

(72) Inventors: Sifan MA, Beijing (CN); Zeqing ZHAO, Beijing (CN)

(21) Appl. No.: 19/183,608

(22) Filed: Apr. 18, 2025

(30) Foreign Application Priority Data
Apr. 30, 2024 (CN) 202410544711.9

(51) Int. Cl. G06F 40/40

(52) U.S. Cl. CPC G06F 40/40

(57) ABSTRACT

A question answering method, an electronic device, and a storage medium are provided in the present disclosure. The question answering method includes, based on a target query message inputted by a user, determining a first profile message in at least one profile message of the user stored in a memory module, where a similarity between the first profile message and the target query message is higher than a first specific threshold; and based on the target query message and the first profile message, using the large language model to determine an answer message of the target query message. At least a part of the at least one profile message stored in the memory module is obtained based on at least one historical conversation message, which satisfies a storage lifecycle-duration condition, of the user interacting with the large language model.

### CROSS-REFERENCE TO RELATED APPLICATION

This application claims the priority of Chinese Patent Application No. 202410544711.9, filed on Apr. 30, 2024, the content of which is incorporated herein by reference in its entirety.

### TECHNICAL FIELD

The present disclosure generally relates to the field of artificial intelligence technology and, more particularly, relates to a question answering method, an electronic device, and a storage medium.

### BACKGROUND

With the development of large language model (LLM) technology, large language models may help users solve more problems.

For on-device large language model, the large language model may be stored locally and used continuously by the user. However, during the interaction between the user and the large language model, the large language model may only remember historical conversation messages with the user in current session and know nothing about other historical conversation messages. Therefore, the memory capacity of the large language model may be very limited and may not gradually have personalized reasoning capabilities as the user continues to use the model more. On-size-fits-all answers may be provided to the user's questions, which may affect the user experience.

To improve the memory capacity of the large language model, in the existing technology, an external memory module may be added to the large language model, and relevant historical conversation messages may be extracted from the memory module when needed to assist the large language model in answering user questions. Such technology may improve the short memory of the large language model to a certain extent. However, the memory module stores a large amount of historical conversation messages during historical interaction between the user and the large language model, which results in that the memory module may need to occupy a large amount of memory space.

### SUMMARY

One aspect of the present disclosure provides a question answering method. The method includes, based on a target query message inputted by a user, determining a first profile message in at least one profile message of the user stored in a memory module, where a similarity between the first profile message and the target query message is higher than a first specific threshold; and based on the target query message and the first profile message, using the large language model to determine an answer message of the target query message. At least a part of the at least one profile message stored in the memory module is obtained based on at least one historical conversation message, which satisfies a storage lifecycle-duration condition, of the user interacting with the large language model.

Another aspect of the present disclosure provides an electronic device. The electronic device includes a memory, configured to store a computer program; and one or more processors, configured to, when the computer program is executed, perform a question answering method. The method includes, based on a target query message inputted by a user, determining a first profile message in at least one profile message of the user stored in a memory module, where a similarity between the first profile message and the target query message is higher than a first specific threshold; and based on the target query message and the first profile message, using the large language model to determine an answer message of the target query message. At least a part of the at least one profile message stored in the memory module is obtained based on at least one historical conversation message, which satisfies a storage lifecycle-duration condition, of the user interacting with the large language model.

Another aspect of the present disclosure provides a non-transitory computer-readable storage medium, containing a computer program for when executed by one or more processors, performing a question answering method. The method includes, based on a target query message inputted by a user, determining a first profile message in at least one profile message of the user stored in a memory module, where a similarity between the first profile message and the target query message is higher than a first specific threshold; and based on the target query message and the first profile message, using the large language model to determine an answer message of the target query message. At least a part of the at least one profile message stored in the memory module is obtained based on at least one historical conversation message, which satisfies a storage lifecycle-duration condition, of the user interacting with the large language model.

Other aspects of the present disclosure may be understood by those skilled in the art in light of the description, the claims, and the drawings of the present disclosure.

### BRIEF DESCRIPTION OF THE DRAWINGS

In order to more clearly illustrate the technical solutions of embodiments of the present disclosure, accompanying drawings needed in embodiments of the present disclosure are described hereinafter. Obviously, accompanying drawings described below are some embodiments of the present disclosure. For those skilled in the art, other drawings may also be obtained based on the accompanying drawings without creative work.

FIG. 1 illustrates a flowchart of a question answering method based on a large language model according to various embodiments of the present disclosure.

FIG. 2 illustrates another flowchart of a question answering method based on a large language model according to various embodiments of the present disclosure.

FIG. 3 illustrates a flowchart of updating a lifecycle duration of a historical conversation message stored in a memory module according to various embodiments of the present disclosure.

FIG. 4 illustrates a flowchart of updating a user profile message stored in a memory module according to various embodiments of the present disclosure.

FIG. 5 illustrates a schematic of a memory module storing a user profile message and a historical conversation message according to various embodiments of the present disclosure.

FIG. 6 illustrates a schematic of determining a user profile message according to various embodiments of the present disclosure.

FIG. 7 illustrates a structural schematic of a question answering apparatus based on a large language model according to various embodiments of the present disclosure.

FIG. 8 illustrates an entity structural schematic of an electronic device according to various embodiments of the present disclosure.

### DETAILED DESCRIPTION

To clearly describe the objectives, the technical solutions and advantages of the present disclosure, the technical solutions of the present disclosure are further described in detail below in combination with accompanying drawings and embodiments. Obviously, the described embodiments are only a part of embodiments of the present disclosure, rather than all embodiments. All other embodiments obtained by those skilled in the field without creative work are within the protection scope of the present disclosure.

It should be noted that in the description of embodiments of the present disclosure, the terms “first”, “second” and the like may be used to distinguish similar objects, rather than to describe a specific order or precedence. It may be understood that the data used in such way may be interchangeable under appropriate circumstances, such that embodiments of the present disclosure may be implemented in an order other than the orders illustrated or described here. Furthermore, the objects distinguished by “first”, “second” and the like may be one type, and the quantity of objects may be not limited. For example, the quantity of the first objects may be one or more.

In conjunction with accompanying drawings in embodiments of the present disclosure, a question answering method based on a large language model, a question answering apparatus, and an electronic device provided in embodiments of the present disclosure are exemplarily introduced hereinafter.

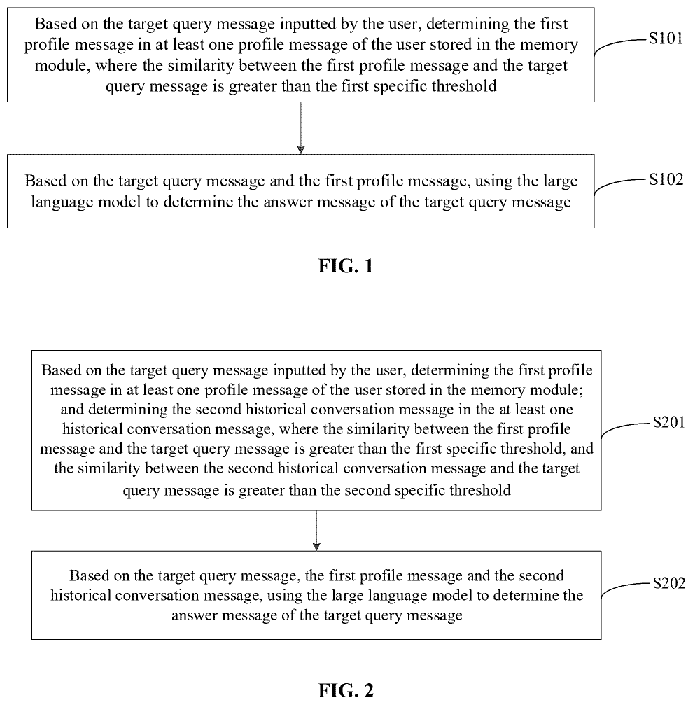

FIG. 1 illustrates a flowchart of a question answering method based on a large language model according to various embodiments of the present disclosure. Referring to FIG. 1, the question answering method may include following exemplary steps.

At S101, on a target query message inputted by a user, a first profile message in at least one profile message of the user stored in a memory module may be determined, where a similarity between the first profile message and the target query message may be higher than a first specific threshold.

At least a part of at least one profile message stored in the memory module may be obtained based on at least one historical conversation message, which satisfies the storage lifecycle-duration condition, of the interaction between the user and the large language model.

In some embodiments, the large language model may be externally configured with a memory module. The memory module may store the at least one profile message of the user. Each profile message may characterize at least one of the following user's personal information types including user occupation, the field which the user occupation belongs to, user answer preference, user questioning-manner preference, and user commonly used office tools and the like.

In some embodiments, the stored lifecycle duration of the historical conversation message of the user interacting with the large language model may be configured, such that the historical conversation message of the user interacting with the large language model may be stored in the memory module according to the stored lifecycle duration. The stored lifecycle duration may be a limit on the storage duration of each historical conversation message. For example, the stored lifecycle duration of a certain historical conversation message may be configured to one day, one week, or one month. When the stored lifecycle duration of the historical conversation message reaches corresponding lifecycle duration, the lifecycle duration of the historical conversation message may be extended for a certain duration, or the historical conversation message may be automatically deleted from the memory module based on a certain instruction.

In some embodiments, in response to that the storage duration of a certain historical conversation message in the memory module reaches corresponding lifecycle duration, the lifecycle duration of the historical conversation message may be extended based on similarity or correlation between the historical conversation message and the target query message inputted by the user; and in response to that the quantity of extensions of the lifecycle duration of the historical conversation message is greater than a specific quantity of extensions, the lifecycle duration of the historical conversation message may be updated to permanent duration.

It may be understood that the historical conversation message which satisfies the storage lifecycle-duration condition may characterize that the lifecycle duration of the historical conversation message currently stored in the memory module may be permanent duration and may be not limited to permanent duration; or in response to that the lifecycle duration exceeds a certain threshold, such as one year, the condition may be also considered to be satisfied.

In some embodiments, at least a part of the profile messages of the user may be determined and stored in the memory module based on at least one historical conversation message, which satisfies the storage lifecycle-duration condition, of the user interacting with the large language model.

It should be noted that at least a part of the at least one profile message stored in the memory module may be obtained based on at least one historical conversation message, which satisfies the storage lifecycle-duration condition, of the user interacting with the large language model. At least a part of the profile messages may be all profile messages in the at least one profile message stored in the memory module or a part of the profile messages in the at least one profile message stored in the memory module.

It should be noted that at least one historical conversation message, which satisfies the storage lifecycle-duration condition, of the user interacting with the large language model may be mined to obtain at least a part of the profile messages of the user which may be stored in the memory module.

It should be noted that historical conversation messages may be lengthy and need a large memory space. Compared with lengthy historical conversation messages, the user profile message obtained by mining historical conversation messages may be more concise, such that the user profile message may occupy less memory space.

In some embodiments, the target query message inputted by the user may be the question message that the user needs to ask the large language model. Based on the target query message inputted by the user, the first profile message may be determined from at least one profile message of the user stored in the memory module, and the similarity between the first profile message and the target query message inputted by the user may be higher than the first specific threshold.

It should be noted that the first specific threshold may be adaptively configured based on actual applications, which may not be limited in embodiments of the present disclosure. For example, the first specific threshold may be 60%, 75%, 80%, 90% or the like.

It should be noted that, since the similarity between the first profile message and the target query message inputted by the user is higher than the first specific threshold, it characterizes that the first profile message and the target query message inputted by the user may have relatively high similarity or relatively strong correlation.

At S102, based on the target query message and the first profile message, the answer message of the target query message may be determined using the large language model.

In some embodiments, the first profile message determined in exemplary S101 may be configured as a prompt message for the large language model to reason the answer message; and the target query message inputted by the user and the first profile message of the user may be inputted into the large language model to obtain the answer message of the target query message outputted by the large language model.

It should be noted that the prompt message may assist the large language model to give a desirable answer to the question of the user. In the existing technology, a fixed embedded prompt template may be configured to assist the large language model; that is, the input message of the user may be filled into the prompt template. However, the fixed prompt template may lack flexibility, which may be easy to conflict with the input message of the user and may not adapt to different users. In embodiments of the present disclosure, the first profile message of the user may be configured as the prompt message for the large language model to reason the answer message, which may avoid the case where the fixed embedded prompt template conflicts with the input message of the user.

It should be noted that, since the large language model has a limit on the maximum input sequence length, the historical conversation message exceeding the maximum input sequence length cannot be configured as the prompt message which is inputted into the large language model to assist the large language model in answering user questions. However, in embodiments of the present disclosure, the first profile message of the user may be configured as the prompt message to assist the large language model in answering user questions. Compared with using lengthy historical conversation message as the prompt message, using more concise first profile message of the user as prompt message may avoid the input message length of the large language model exceeding the limit of the maximum input sequence length.

It may be understood that for the question answering method based on the large language model provided in embodiments of the present disclosure, the first profile message of at least one profile message of the user stored in the memory module may be first determined based on the target query message inputted by the user, and the similarity between the first profile message and the target query message may be higher than the first specific threshold; and then the answer message of the target query message may be determined based on the target query message inputted by the user and the first profile message using the large language model. The memory module may store at least one profile message of the user and at least one historical conversation message of the user interacting with the large language model, and at least a part of the at least one profile message of the user may be obtained based on at least one historical conversation message that satisfies the storage lifecycle-duration condition. Compared with the solution of storing a large amount of historical conversation messages in the memory module during the historical interaction between the user and the large language model in the existing technology, the memory space occupied by the memory module may be reduced, and finally the large language model may be assisted in reasoning the answer message based on the first profile message of the user, which may avoid the input message length of the large language model exceeding the limit of the maximum input sequence length.

In some embodiments, the question answering method based on the large language model may further includes, when determining that the stored lifecycle duration of the first historical conversation message in the at least one historical conversation message is permanent duration, the second profile message of the user may be determined using the large language model based on the first historical conversation message; and in response to that the at least one profile message stored in the memory module does not include the second profile message, the second profile message may be stored in the memory module, where the second profile message may belong to at least a part of the profile messages.

In embodiments of the present disclosure, the lifecycle duration of each historical conversation message stored in the memory module may be different. In response to that it is determined that the lifecycle duration stored in the first historical conversation message in at least one historical conversation message is permanent duration, the second profile message of the user may be determined based on the first historical conversation message using the large language model; and furthermore, in response to that it is determined that at least one profile message stored in the memory module does not include the second profile message, the second profile message may be stored in the memory module, where the second profile message may belong to at least a part of the profile messages in the at least one profile message stored in the memory module.

In some embodiments, in response to that the similarity or correlation between a certain historical conversation message in at least one historical conversation message and the query message inputted by the user is higher or stronger, the lifecycle duration of the historical conversation message stored in the memory module may be configured to be longer. In response to that the lifecycle duration stored in the first historical conversation message is permanent duration, it characterizes that the similarity or correlation between the first historical conversation message and the query message inputted by the user is higher, such that the large language model may be configured to mine the first historical conversation message to obtain the second profile message of the user. In response to that the at least one profile message stored in the memory module does not include the second profile message, the second profile message may be stored in the memory module, such that the second profile message may be obtained from the memory module later to desirably assist the large language model in reasoning the answer message.

It may be understood that in embodiments of the present disclosure, the second profile message may be obtained and stored in the memory module by mining the first historical conversation message that the lifecycle duration stored is permanent duration. The lifecycle duration of the first historical conversation message being permanent duration may characterize that the first historical conversation message may have higher similarity or stronger correlation with the query message inputted by the user, which may be beneficial for obtaining the second profile message from the memory module subsequently, thereby desirably assisting the large language model in reasoning the answer message.

In some embodiments, the question answering method based on the large language model may further include, based on the target query message, determining the second historical conversation message in the at least one historical conversation message, where the similarity between the second historical conversation message and the target query message may be higher than a second specific threshold.

Determining the answer message of the target query message using the large language model based on the target query message and the first profile message may include determining the answer message of the target query message using the large language model based on the target query message, the first profile message and the second historical conversation message.

In embodiments of the present disclosure, the second historical conversation message in at least one historical conversation message stored in the memory module may be determined based on the target query message inputted by the user; and the similarity between the second historical conversation message and the target query message inputted by the user may be higher than the second specific threshold. Furthermore, the answer message of the target query message may be determined using the large language model based on the target query message inputted by the user, the first profile message determined in exemplary step S101 and the second historical conversation message.

It should be noted that, since the similarity between the second historical conversation message and the target query message is higher than the second specific threshold, it characterizes that the second historical conversation message and the query message inputted by the user may have higher similarity or stronger correlation.

It should be noted that the second specific threshold may be adaptively configured based on actual applications, which may not be limited in embodiments of the present disclosure. For example, the second specific threshold may be 70%, 85%, 90% or the like.

In some embodiments, the first profile message and the second historical conversation message may be configured as the prompt message for the large language model to reason the answer message; and the target query message inputted by the user, the first profile message of the user, and the second historical conversation message of the user interacting with the large language model may be inputted into the large language model to obtain the answer message of the target query message outputted by the large language model.

Exemplarily, FIG. 2 illustrates another flowchart of a question answering method based on a large language model according to various embodiments of the present disclosure. As shown in FIG. 2, the question answering method may include following exemplary steps.

At S201, based on the target query message inputted by the user, the first profile message in the at least one profile message of the user stored in the memory module may be determined, and the second historical conversation message in the at least one historical conversation message of the user interacting with the large language model may be determined, where the similarity between the first profile message and the target query message may be higher than the first specific threshold, and the similarity between the second historical conversation message and the target query message may be higher than the second specific threshold.

At S202, based on the target query message, the first profile message and the second historical conversation message, the answer message of the target query message may be determined using the large language model.

It may be understood that, in embodiments of the present disclosure, the first profile message and the second historical conversation message stored in the memory module may be configured as the prompt message for the large language model to reason the answer message; and compared with using only the first profile message stored in the memory module as the prompt message for the large language model to reason the answer message mentioned above, the large language model may improve the answer effect of the target query message inputted by the user.

In some embodiments, the at least one historical conversation message may be stored in the memory module according to corresponding lifecycle duration.

After determining the second historical conversation message in the at least one historical conversation message based on the target query message, the method may further include extending the lifecycle duration of the second historical conversation message stored in the memory module from original first specific duration to the second specific duration.

In embodiments of the present disclosure, at least one historical conversation message of the user interacting with the large language model may be stored in the memory module according to corresponding lifecycle duration. In response to that it is determined that the second historical conversation message is in the at least one historical conversation message stored in the memory module based on the target query message inputted by the user, and in response to that the similarity between the second historical conversation message and the target query message inputted by the user is higher than the second specific threshold, the lifecycle duration of the second historical conversation message stored in the memory module may be extended from original first specific duration to the second specific duration.

It should be noted that the difference between the first specific duration and the second specific duration may not be limited in embodiments of the present disclosure and may be adaptively configured based on actual applications.

For example, after obtaining corresponding user profile message based on a historical conversation message, the lifecycle duration of the profile message stored in the memory module may be configured to be duration a. In response to that the similarity between the target query message inputted by the subsequent user and the historical conversation message is higher than the second specific threshold, the lifecycle duration of the historical conversation message stored in the memory module may be extended from duration a to duration b.

It may be understood that in embodiments of the present disclosure, the dynamic update of the lifecycle duration of the second historical conversation message stored in the memory module may be effectively implemented by extending the lifecycle duration of the second historical conversation message that the similarity with the target query message inputted by the user is higher than the second specific threshold, which may be beneficial for subsequently obtaining the second historical conversation message from the memory module in a longer time, thereby desirably assisting the large language model in reasoning the answer message.

In some embodiments, after the lifecycle duration of the second historical conversation message stored in the memory module is extended from original first specific duration to the second specific duration, the method may further include, when determining that the quantity of extensions of the lifecycle duration of the second historical conversation message stored in the memory module is greater than a specific extension quantity, the lifecycle duration of the second historical conversation message stored in the memory module may be updated to permanent duration.

In embodiments of the present disclosure, the quantity of extensions of the lifecycle duration of each historical conversation message stored in the memory module may be marked. In response to that the lifecycle duration of the second historical conversation message stored in the memory module is extended from original first specific duration to the second specific duration, current quantity of extensions of the lifecycle duration of the second historical conversation message stored in the memory module may be determined. In response to determining that the extension quantity is greater than the specific extension quantity, the lifecycle duration of the second historical conversation message stored in the memory module may be updated to permanent duration.

It should be noted that the specific extension times may be adaptively configured based on actual applications, which may not be limited in embodiments of the present disclosure. For example, the specific extension times may be 5 times, 10 times, 20 times or the like.

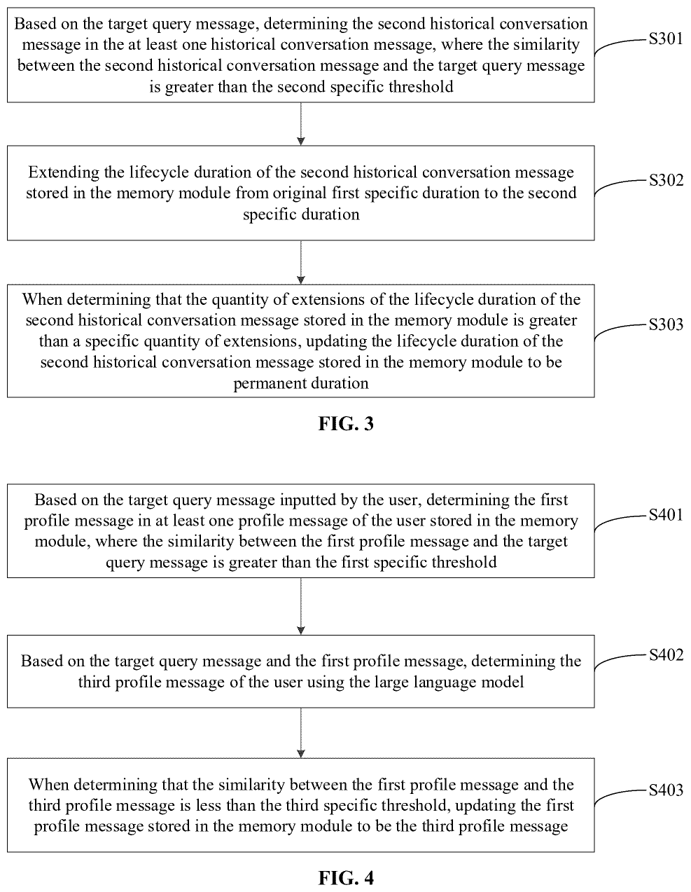

Exemplarily, FIG. 3 illustrates a flowchart of updating the lifecycle duration of a historical conversation message stored in the memory module according to various embodiments of the present disclosure. As shown in FIG. 3, the method may include following exemplary steps.

At S301, based on the target query message inputted by the user, the second historical conversation message in at least one historical conversation message stored in the memory module may be determined, where the similarity between the second historical conversation message and the target query message may be higher than the second specific threshold.

At S302, the lifecycle duration of the second historical conversation message stored in the memory module may be extended from original first specific duration to the second specific duration.

At S303, when determining that the quantity of extensions of the lifecycle duration of the second historical conversation message stored in the memory module is greater than the specific extension quantity, the lifecycle duration of the second historical conversation message stored in the memory module may be updated to permanent duration.

It may be understood that in response to that the quantity of extensions of the lifecycle duration of the second historical conversation message stored in the memory module is greater than the specific quantity of extensions, it characterizes that the second historical conversation message may have relatively strong correlation with the query messages inputted by the user multiple times. In such scenario, the lifecycle duration of the second historical conversation message stored in the memory module may be updated to permanent duration, which may further implement the dynamic update of the lifecycle duration of the second historical conversation message stored in the memory module and may be beneficial for permanently obtaining the second historical conversation message from the memory module subsequently, thereby desirably assisting the large language model in reasoning the answer message.

It may be understood that in embodiments of the present disclosure, the lifecycle duration of the historical conversation message stored in the memory module may be flexibly and dynamically updated, and the historical conversation message may be converted into the profile message when the stored lifecycle duration satisfies the condition, instead of storing each historical conversation message in the memory module according to a fixed lifecycle. In such way, it may not only effectively reduce the memory space occupied by the memory module but also process more relevant historical conversation messages to obtain profile messages and permanently use valid information of historical conversation messages.

In some embodiments, the question answering method based on the large language model may further include, based on the target query message and the first profile message, using the large language model to determine the third profile message of the user; and when determining that the similarity between the first profile message and the third profile message is less than the third specific threshold, updating the first profile message stored in the memory module to the third profile message.

In embodiments of the present disclosure, the third profile message of the user may be determined using the large language model based on the target query message inputted by the user and the first profile message of the user, and when determining that the similarity between the first profile message of the user and the third profile message of the user is less than the third specific threshold, the first profile message stored in the memory module may be updated to the third profile message.

It should be noted that the third specific threshold may be adaptively configured based on actual applications, which may not be embodiments of the present disclosure. For example, the third specific threshold may be 70%, 80%, 90%, or the like.

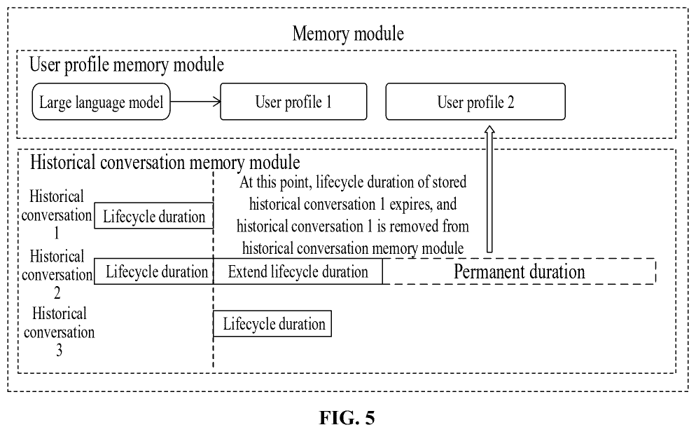

Exemplarily, FIG. 4 illustrates a flowchart of updating the user profile message stored in the memory module according to various embodiments of the present disclosure. As shown in FIG. 4, the method may include following exemplary steps.

At S401, based on the target query message inputted by the user, the first profile message of at least one profile message of the user stored in the memory module may be determined, where the similarity between the first profile message and the target query message may be higher than the first specific threshold.

At S402, based on the target query message and the first profile message, the third profile message of the user using the large language model may be determined.

At S403, when determining that the similarity between the first profile message and the third profile message is less than the third specific threshold, the first profile message stored in the memory module may be updated to the third profile message.

It may be understood that in embodiments of the present disclosure, secondary output of the large language model may be added; that is, in addition to determining the answer message of the target query message based on the target query message and the first profile message using the large language model, the third profile message of the user may be determined based on the target query message and the first profile message using the large language model, and when determining that the similarity between the first profile message and the third profile message is less than the third specific threshold, the first profile message stored in the memory module may be updated to the third profile message. In such way, the profile message of the user stored in the memory module may be more consistent with current profile of the user, and the dynamic update of the profile message of the user stored in the memory module may be effectively implemented.

In some embodiments, the question answering method based on the large language model may further include fine-tuning the large language model under supervision based on a sample training data set. The sample training data set may include at least one sample training data, each of the sample training data may include sample data and label data corresponding to the sample data, the sample data may include sample query message carrying the first sample profile message of the user, and the label data may include the second sample profile message corresponding to the sample query message.

In embodiments of the present disclosure, before using the large language model to mine historical conversation messages or target query messages inputted by the user to obtain the user profile message, supervised fine-tune (SFT) may be performed on the large language model based on the sample training data, thereby enhancing the large language model's ability to mine the user profile message. The sample training data set may include at least one sample training data, and each sample training data may include sample data and label data corresponding to the sample data, the sample data may include the sample query message carrying the first sample profile message of the user, and the label data may include the second sample profile message corresponding to the sample query message.

It may be understood that in embodiments of the present disclosure, the mining ability of the large language model for the user's profile message may be enhanced by apply SFT to the large language model based on the sample training data set, thereby obtaining information that is more consistent with the user's actual profile.

In some embodiments, the other part of the profile messages in the at least one profile message stored in the memory module may be obtained based on the source data messages uploaded by the user and stored in the plug-in knowledge base of the large language model.

In embodiments of the present disclosure, the large language model may be plugged with a knowledge base. The knowledge base may store source data information related to the user, and the source data information may include certain information related to the user's work or life. The source data information may be mined to obtain partial user profile message which may be stored in the memory module.

It may be understood that in embodiments of the present disclosure, partial user profile message may be obtained and stored in the memory module based on the source data messages uploaded by the user and stored in the plug-in knowledge base of the large language model, such that the memory module may store more comprehensive user profile message to desirably assist the large language model in reasoning the answer message.

Exemplarily, FIG. 5 illustrates a schematic of the memory module storing the user profile message and the historical conversation message according to various embodiments of the present disclosure. As shown in FIG. 5, the memory module may include two parts including the user profile memory module and the historical conversation memory module. The user profile memory module may be configured to store each user profile obtained by mining based on the large language model, and the historical conversation memory module may be configured to store each historical conversation of the user interacting with the large language model. For the historical conversation 2 stored in the historical conversation memory module, it may be seen from FIG. 5 that after the lifecycle duration of the historical conversation 2 is extended twice, the lifecycle of the historical conversation 2 may be updated to permanent duration. At this point, the historical conversation 2 may be mined using the large language model to obtain the user profile 2 which may be stored in the user profile memory module. For the historical conversation 3 stored in the historical conversation memory module, when the historical conversation 3 appears, the lifecycle duration of the historical conversation 1 may have expired, and the historical conversation 1 may automatically disappear (removed) from the historical conversation memory module.

It should be noted that the historical conversation memory module may maintain the lifecycle durations of all historical conversations. All historical conversations may be first stored indiscriminately with a configured lifecycle. When a new historical conversation enters, the relevance with existing historical conversation may be calculated. In response to that there is a relevant target historical conversation, the lifecycle duration of the target historical conversation may be extended. When the lifecycle duration of the target historical conversation is extended a certain quantity of extensions, the lifecycle duration of the target historical conversation may be updated to permanent duration. At this point, the target historical conversation may be refined or mined with the help of the large language model to obtain the user profile which may be stored in the user profile memory module.

In some embodiments, the lifecycle duration of each profile message stored in the memory module may be similarly configured according to the dynamic update manner of the lifecycle duration of the historical conversation message stored in the memory module. For example, when a new historical conversation enters, the user profile memory module may also calculate the correlation between the new historical conversation and existing user profile to further update the lifecycle duration of each user profile, thereby realizing the lifecycle management of the user profile memory module.

In some embodiments, when the large language model receives the target query message inputted by the user, the large language model may first call the memory module shown in FIG. 5, search for the user profile and historical conversation related to the target query message from the user profile memory module and the historical conversation memory module respectively, and then use searched user profile and historical conversation as the prompt message to assist the large language model in reasoning the answer message. It may be understood that in embodiments of the present disclosure, the storage and search pressure of the large language model on information may be greatly reduced through the design of the user profile memory module and the historical conversation memory module.

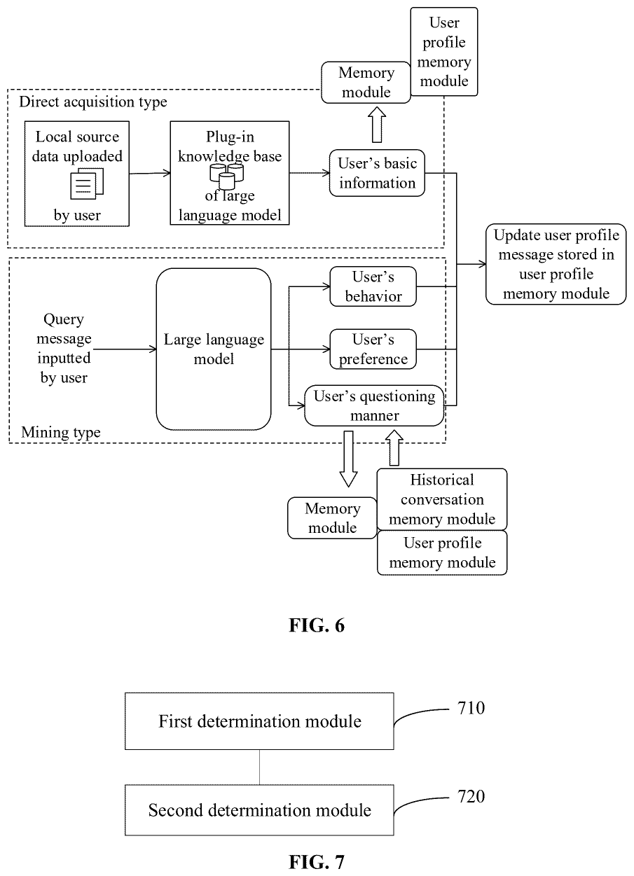

Exemplarily, FIG. 6 illustrates a schematic of determining the user profile message according to various embodiments of the present disclosure. As shown in FIG. 6, the manners for obtaining the user profile message may include a direct acquisition type and a mining type. For the direct acquisition type, the local source data uploaded by the user to the plug-in knowledge base of the large language model may be mined to obtain the user's basic information, which may be partial user profile message, and obtained user basic information may be stored in the user profile memory module in the memory module. For the mining type, that is, above-mentioned manner in the present disclosure, the user profile message may be obtained based on the historical conversation message of the user; the query message inputted by the user each time may be mined using the large language model to obtain partial user profile message (including user behavior, user preference and user questioning manner) which may be stored in the user profile memory module of the memory module; and the query message inputted previously (historically) by the user may be stored in the historical conversation memory module of the memory module. In addition, for new user profile message obtained by the direct acquisition type and the mining type, it may determine whether it is necessary to use new user profile message to update original user profile message stored in the user profile memory module.

It should be noted that for the mining type, in each question asked by the user, the large language model may mine the user's behavior, preference and questioning manner to obtain new user profile message which may be configured to update and maintain the user profile message originally stored in the user profile memory module.

It may be understood that in embodiments of the present disclosure, more intelligent information memory management may be implemented by mining and selecting the source data information of the historical conversation message and the user-uploaded plug-in knowledge base, which may selectively memorize effective historical conversation message. As the user interacts with the large language model, the large language model may continue to be familiar with the user profile and give a reply that is more consistent with the user's needs and habits, thereby providing personalized question answering for individuals.

A question answering apparatus based on the large language model provided in embodiments of the present disclosure is described hereinafter. The question answering apparatus based on the large language model described below may refer to the question answering method based on the large language model described above.

FIG. 7 illustrates a structural schematic of a question answering apparatus based on a large language model according to various embodiments of the present disclosure. As shown in FIG. 7, the apparatus may include the first determination module 710 and the second determination module 720.

The first determination module 710 may be configured to determine the first profile message of at least one profile message of the user stored in the memory module based on the target query message inputted by the user, where the similarity between the first profile message and the target query message may be higher than the first specific threshold.

The second determination module 720 may be configured to determine the answer message of the target query message using the large language model based on the target query message and the first profile message.

At least a part of at least one profile message stored in the memory module may be obtained based on at least one historical conversation message, which satisfies the storage lifecycle-duration condition, of the interaction between the user and the large language model.

For the question answering apparatus based on the large language model provided in embodiments of the present disclosure, the first profile message of at least one profile message of the user stored in the memory module may be first determined based on the target query message inputted by the user, and the similarity between the first profile message and the target query message may be higher than the first specific threshold; and then the answer message of the target query message may be determined based on the target query message inputted by the user and the first profile message using the large language model. The memory module may store at least one profile message of the user and at least one historical conversation message of the user interacting with the large language model, and at least a part of the at least one profile message of the user may be obtained based on at least one historical conversation message that satisfies the storage lifecycle-duration condition. Compared with the solution of storing a large amount of historical conversation messages in the memory module during the historical interaction between the user and the large language model in the existing technology, the memory space occupied by the memory module may be reduced, and finally the large language model may be assisted in reasoning the answer message based on the first profile message of the user, which may avoid the input message length of the large language model exceeding the limit of the maximum input sequence length.

In some embodiments, the apparatus may further include the third determination module, configured to determine the second profile message of the user based on the first historical conversation message using the large language model when determining that the lifecycle duration stored in the first historical conversation message in the at least one historical conversation message is permanent duration; and a storage module, configured to store the second profile message in the memory module in response to that the at least one profile message stored in the memory module does not include the second profile message, where the second profile message may belong to at least a part of the profile messages.

In some embodiments, the apparatus may further include the fourth determination module, configured to determine the second historical conversation message in the at least one historical conversation message based on the target query message, where the similarity between the second historical conversation message and the target query message may be higher than the second specific threshold; and the second determination module 720, configured to determine the answer message of the target query message using the large language model based on the target query message, the first profile message and the second historical conversation message.

In some embodiments, the at least one historical conversation message may be stored in the memory module according to corresponding lifecycle duration.

The fourth determination module may be also configured to, after determining the second historical conversation message in the at least one historical conversation message based on the target query message, extend the lifecycle duration of the second historical conversation message stored in the memory module from original first specific duration to the second specific duration.

In some embodiments, the fourth determination module may be further configured to, after extending the lifecycle duration of the second historical conversation message stored in the memory module from original first specific duration to the second specific duration, in response to determining that the quantity of extensions of the lifecycle duration of the second historical conversation message stored in the memory module is greater than the specific extension quantity, update the lifecycle duration of the second historical conversation message stored in the memory module to permanent duration.

In some embodiments, the apparatus may further include the fifth determination module, configured to determine the third profile message of the user using the large language model based on the target query message and the first profile message; and an update module, configured to update the first profile message stored in the memory module to the third profile message when determining that the similarity between the first profile message and the third profile message is less than the third specific threshold.

In some embodiments, the apparatus may further include a training module, configured to fine-tune the large language model under supervision based on the sample training data set. The sample training data set may include at least one sample training data, and each sample training data may include sample data and label data corresponding to the sample data, the sample data may include the sample query message carrying the first sample profile message of the user, and the label data may include the second sample profile message corresponding to the sample query message.

In some embodiments, the other part of the profile messages in the at least one profile message stored in the memory module may be obtained based on the source data messages uploaded by the user and stored in the plug-in knowledge base of the large language model.

It should be noted that above-mentioned question answering apparatus based on the large language model provided in embodiments of the present disclosure may implement all exemplary steps in above-mentioned question answering method embodiments based on the large language model and may achieve same technical effect; and the parts of the question answering apparatus same as above-mentioned method embodiments of the present disclosure and corresponding beneficial effects may be not described in detail herein.

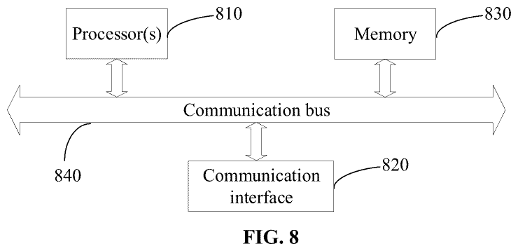

FIG. 8 illustrates an entity structural schematic of an electronic device according to various embodiments of the present disclosure. As shown in FIG. 8, the electronic device may include a processor 810, a communications interface 820, a memory 830, and a communication bus 840, where the processor 810, the communications interface 820, and the memory 830 may communicate with each other through the communication bus 840. The processor 810 may call executable data instructions stored in the memory 830 to execute a part of or all exemplary steps in the question answering method based on the large language model provided in above-mentioned embodiments.

In addition, the executable data instructions stored in above-mentioned memory 830 may be implemented in the form of a software functional unit and may be stored in a computer-readable storage medium when being sold or used as an independent product. Based on such understanding, the essence of the technical solution of the present disclosure, or a part of the technical solution which may contribute to the existing technology, or a part of the technical solution may be embodied in the form of a software product. The computer software product may be stored in a storage medium and include certain instructions for a computer device (which may be a personal computer, a server, or a network device or the like) to perform all or part of exemplary steps of the methods described in each embodiment of the present disclosure. Above-mentioned storage media may include various media capable of storing program codes, including U disk, mobile hard disk, read-only memory (ROM), random access memory (RAM), disk, optical disk or the like.

Embodiments of the present disclosure further provide a computer-readable storage medium. The computer-readable storage medium may store a computer program, and when the computer program is executed by the processor, a part of or all exemplary steps of the question answering method based on the large language model provided in above-mentioned methods may be implemented.

Embodiments of the present disclosure further provide a computer program product. The computer program product may include a computer program stored in a computer-readable storage medium, and the computer program may include program instructions. When the program instructions are executed by a computer, the computer may execute a part of or all exemplary steps of the question answering method based on the large language model provided in above-mentioned methods.

Various embodiments of the present disclosure provide an electronic device. The electronic device includes a memory, configured to store a computer program; and one or more processors, configured to, when the computer program is executed, perform a question answering method. The method includes, based on a target query message inputted by a user, determining a first profile message in at least one profile message of the user stored in a memory module, where a similarity between the first profile message and the target query message is higher than a first specific threshold; and based on the target query message and the first profile message, using the large language model to determine an answer message of the target query message. At least a part of the at least one profile message stored in the memory module is obtained based on at least one historical conversation message, which satisfies a storage lifecycle-duration condition, of the user interacting with the large language model.

Various embodiments of the present disclosure provide a non-transitory computer-readable storage medium, containing a computer program for when executed by one or more processors, performing a question answering method. The method includes, based on a target query message inputted by a user, determining a first profile message in at least one profile message of the user stored in a memory module, where a similarity between the first profile message and the target query message is higher than a first specific threshold; and based on the target query message and the first profile message, using the large language model to determine an answer message of the target query message. At least a part of the at least one profile message stored in the memory module is obtained based on at least one historical conversation message, which satisfies a storage lifecycle-duration condition, of the user interacting with the large language model.

Apparatus embodiments described above may be merely exemplary. The units described as separate parts may or may not be physically separated; and the units (parts) for display may or may not be physical units, that is, may be in one place or may be distributed on multiple network units. A part of or all modules may be selected according to actual needs to implement the solutions of embodiments of the present disclosure. Those skilled in the art may understand and implement embodiments of the present disclosure without creative work.

It should be understood by those skilled in the art that embodiments of the present disclosure may be provided as methods, systems, or computer program products. Therefore, the present disclosure may take the form of hardware embodiments, software embodiments, or embodiments combining software and hardware. Moreover, the present disclosure may take the form of a computer program product implemented on one or more computer-usable storage media (including but not limited to disk storage and optical storage and the like) containing computer-usable program codes.

The present disclosure is described with reference to the flowcharts and/or block diagrams of the methods, apparatuses, devices (systems), and computer program products according to embodiments of the present disclosure. It can be understood that each process and/or box in the flowchart and/or block diagram, as well as the combination of processes and/or boxes in the flowchart and/or block diagram, may be implemented by computer program instructions. The computer program instructions may be provided to processors of a general-purpose computer, a special-purpose computer, an embedded processor, or other programmable data processing device to produce a machine. In such way, the instructions executed by the processor of the computer or other programmable data processing device may generate an apparatus for implementing functions specified in one or more processes in the flowchart and/or one or more boxes in the block diagram.

The computer program instructions may also be stored in a computer-readable memory that may guide a computer or other programmable data processing device to work in certain manner, such that the instructions stored in the computer-readable memory may generate a product including an instruction apparatus that implements functions specified in one or more processes of the flowchart and/or one or more boxes of the block diagram.

The computer program instructions may also be loaded onto a computer or other programmable data processing device, such that a series of exemplary operation steps may be performed on the computer or other programmable device to generate computer-implemented processing. Therefore, the instructions executed on the computer or other programmable device may provide exemplary steps for implementing functions specified in one or more processes of the flowchart and/or one or more boxes of the block diagram.

The above may be merely optional embodiments of the present disclosure and may be not intended to limit the protection scope of the present disclosure.

What is claimed is:

1. A question answering method, based on a large language model, comprising:
based on a target query message inputted by a user, determining a first profile message in at least one profile message of the user stored in a memory module, wherein a similarity between the first profile message and the target query message is higher than a first specific threshold; and
based on the target query message and the first profile message, using the large language model to determine an answer message of the target query message, wherein:
at least a part of the at least one profile message stored in the memory module is obtained based on at least one historical conversation message, which satisfies a storage lifecycle-duration condition, of the user interacting with the large language model.

2. The method according to claim 1, further including:
when determining that a stored lifecycle duration of a first historical conversation message in the at least one historical conversation message is permanent duration, determining a second profile message of the user using the large language model based on the first historical conversation message; and
in response to that the at least one profile message stored in the memory module does not include the second profile message, storing the second profile message in the memory module, wherein the second profile message belongs to at least the part of the at least one profile message.

3. The method according to claim 1, further including:
based on the target query message, determining a second historical conversation message in the at least one historical conversation message, wherein a similarity between the second historical conversation message and the target query message is higher than a second specific threshold; and
using the large language model to determine the answer message of the target query message based on the target query message and the first profile message includes:
using the large language model to determine the answer message of the target query message based on the target query message, the first profile message, and the second historical conversation message.

4. The method according to claim 3, wherein:
the at least one historical conversation message is stored in the memory module according to corresponding lifecycle durations respectively; and
after determining the second historical conversation message in the at least one historical conversation message based on the target query message, the method further includes:
extending a lifecycle duration of the second historical conversation message stored in the memory module from original first specific duration to a second specific duration.

5. The method according to claim 4, after extending the lifecycle duration of the second historical conversation message stored in the memory module from the original first specific duration to the second specific duration, further including:
when determining that a quantity of extensions of the lifecycle duration of the second historical conversation message stored in the memory module is greater than a specific quantity of extensions, updating the lifecycle duration of the second historical conversation message stored in the memory module to be permanent duration.

6. The method according to claim 1, further including:
based on the target query message and the first profile message, determining a third profile message of the user using the large language model; and
when determining that a similarity between the first profile message and the third profile message is less than a third specific threshold, updating the first profile message stored in the memory module to be the third profile message.

7. The method according to claim 1, further including:
applying supervised fine-tune to the large language model based on a sample training data set, wherein the sample training data set includes at least one sample training data; each sample training data includes sample data and label data corresponding to the sample data; the sample data includes a sample query message carrying a first sample profile message of the user, and the label data includes a second sample profile message corresponding to the sample query message.

8. The method according to claim 1, wherein:
another part of the at least one profile message stored in the memory module is obtained based on source data messages uploaded by the user and stored in a plug-in knowledge base of the large language model.

9. An electronic device, comprising:
a memory, configured to store a computer program; and
one or more processors, configured to, when the computer program is executed, perform:
based on a target query message inputted by a user, determining a first profile message in at least one profile message of the user stored in a memory module, wherein a similarity between the first profile message and the target query message is higher than a first specific threshold; and
based on the target query message and the first profile message, using the large language model to determine an answer message of the target query message, wherein:
at least a part of the at least one profile message stored in the memory module is obtained based on at least one historical conversation message, which satisfies a storage lifecycle-duration condition, of the user interacting with the large language model.

10. The electronic device according to claim 9, wherein the one or more processors are further configured to:
when determining that a stored lifecycle duration of a first historical conversation message in the at least one historical conversation message is permanent duration, determine a second profile message of the user using the large language model based on the first historical conversation message; and
in response to that the at least one profile message stored in the memory module does not include the second profile message, store the second profile message in the memory module, wherein the second profile message belongs to at least the part of the at least one profile message.

11. The electronic device according to claim 9, wherein the one or more processors are further configured to:
based on the target query message, determine a second historical conversation message in the at least one historical conversation message, wherein a similarity between the second historical conversation message and the target query message is higher than a second specific threshold; and
use the large language model to determine the answer message of the target query message based on the target query message and the first profile message includes:
using the large language model to determine the answer message of the target query message based on the target query message, the first profile message, and the second historical conversation message.

12. The electronic device according to claim 11, wherein:
the at least one historical conversation message is stored in the memory module according to corresponding lifecycle durations respectively; and
after determining the second historical conversation message in the at least one historical conversation message based on the target query message, the one or more processors are further configured to:
extend a lifecycle duration of the second historical conversation message stored in the memory module from original first specific duration to a second specific duration.

13. The electronic device according to claim 12, wherein after extending the lifecycle duration of the second historical conversation message stored in the memory module from the original first specific duration to the second specific duration, the one or more processors are further configured to:
when determining that a quantity of extensions of the lifecycle duration of the second historical conversation message stored in the memory module is greater than a specific quantity of extensions, update the lifecycle duration of the second historical conversation message stored in the memory module to be permanent duration.

14. The electronic device according to claim 9, wherein the one or more processors are further configured to:
based on the target query message and the first profile message, determine a third profile message of the user using the large language model; and
when determining that a similarity between the first profile message and the third profile message is less than a third specific threshold, update the first profile message stored in the memory module to be the third profile message.

15. The electronic device according to claim 9, wherein the one or more processors are further configured to:
apply supervised fine-tune to the large language model based on a sample training data set, wherein the sample training data set includes at least one sample training data; each sample training data includes sample data and label data corresponding to the sample data; the sample data includes a sample query message carrying a first sample profile message of the user, and the label data includes a second sample profile message corresponding to the sample query message.

16. The electronic device according to claim 9, wherein:
another part of the at least one profile message stored in the memory module is obtained based on source data messages uploaded by the user and stored in a plug-in knowledge base of the large language model.

17. A non-transitory computer-readable storage medium containing a computer program that when being executed, causes one or more processors to perform:
based on a target query message inputted by a user, determining a first profile message in at least one profile message of the user stored in a memory module, wherein a similarity between the first profile message and the target query message is higher than a first specific threshold; and
based on the target query message and the first profile message, using the large language model to determine an answer message of the target query message, wherein:
at least a part of the at least one profile message stored in the memory module is obtained based on at least one historical conversation message, which satisfies a storage lifecycle-duration condition, of the user interacting with the large language model.

18. The storage medium according to claim 17, wherein the one or more processors are further configured to:
when determining that a stored lifecycle duration of a first historical conversation message in the at least one historical conversation message is permanent duration, determine a second profile message of the user using the large language model based on the first historical conversation message; and
in response to that the at least one profile message stored in the memory module does not include the second profile message, store the second profile message in the memory module, wherein the second profile message belongs to at least the part of the at least one profile message.

19. The storage medium according to claim 17, wherein the one or more processors are further configured to:
based on the target query message, determine a second historical conversation message in the at least one historical conversation message, wherein a similarity between the second historical conversation message and the target query message is higher than a second specific threshold; and
use the large language model to determine the answer message of the target query message based on the target query message and the first profile message includes:
using the large language model to determine the answer message of the target query message based on the target query message, the first profile message, and the second historical conversation message.

20. The storage medium according to claim 19, wherein:
the at least one historical conversation message is stored in the memory module according to corresponding lifecycle durations respectively; and
after determining the second historical conversation message in the at least one historical conversation message based on the target query message, the one or more processors are further configured to:
extend a lifecycle duration of the second historical conversation message stored in the memory module from original first specific duration to a second specific duration.
